(19) United States
(12) Patent Application Publication
(10) Pub. No.: US 2008/0239495 A1
(43) Pub. Date: Oct. 2, 2008

(54) OPTICAL FILTER

(75) Inventors: Chien-Chung Chen, Taichung City (TW); Hen-ta Kang, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/060,274

(22) Filed: Apr. 1, 2008

(30) Foreign Application Priority Data
Apr. 2, 2007 (TW) 96111603

(51) Int. Cl. G02B 5/28

(52) U.S. Cl. 359/580

(57) ABSTRACT

An optical filter including a bump, a first conformal transflective film, a conformal space layer and a second conformal transflective film is provided. The bump has a surface, wherein different areas of the surface have different normal vectors, respectively. Moreover, the first conformal transflective film is disposed on the surface of the bump, while the conformal space layer is disposed on the first conformal transflective film. Besides, the second conformal transflective film is disposed on the conformal space layer. By modulating the thickness of the conformal space layer, different colors is shown after the light is processed by the first conformal transflective film, the conformal space layer and the second conformal transflective film. The optical filter has the advantages of high color saturation and high light transmittance. Furthermore, the optical filter can mitigate color washout phenomenon appeared under large viewing angle.

### CROSS-REFERENCE TO RELATED APPLICATION

This application claims the priority benefit of Taiwan application serial no. 96111603, filed on Apr. 2, 2007. The entirety the above-mentioned patent application is hereby incorporated by reference herein and made a part of specification.

### BACKGROUND OF THE INVENTION

1. Field of the Invention

The present invention relates to an optical filter. More particularly, the present invention relates to an optical filter having a bump.

2. Description of Related Art

Color liquid crystal displays (Color LCDs) is capable of displaying colorful images because color filters are applied therein. The color filters are generally disposed on a transparent substrate. The transparent substrate mainly includes a black matrix (BM), used for shielding light, and color filter films arranged corresponding to the sub-pixels, such as red filter films, green filter films and blue filter films etc. Light with different colors is shown after white light passing through the color filter films, and a colorful display effect is achieved accordingly.

Generally, the color filter films are formed by mixing the resin with pigments having different colors. When white light pass through the color filter films, only the light having a specific wavelength can pass through, such that light with different colors is provided after white light passing through the color filter films. However, when white light passing through the color filter films some of the white light while is absorbed thereby, such that the transmittance of the LCD is lowered. Moreover, the images formed by the light passed through the color filter films usually have a problem of insufficient color saturation because of the trade-off between transmittance and color saturation. Thus, the LCD having conventional color filter films cannot fit the demands of users who require high image quality.

Accordingly, an optical filter illustrated in FIG. 1 is provided. Referring to FIG. 1, the optical filter 100 includes a first transflective film 110, a space layer 120 and a second transflective film 130. Light processed by the optical filter 100 will have a specific wavelength due to the interference, and the wavelength of the light processed by the optical filter 100 can be adjusted by modulating the thickness of the space layer 120, and different colors is shown accordingly. Since the wavelength of the light can be accurately adjusted, the light processed by the optical filter 100 may have high color saturation, meanwhile the light transmittance is above 70 percent. In brief, the optical filter 100 has the advantages of high color saturation and high light transmittance.

However, when users watch the LCD from a large viewing angle, the light transmitting along a direction of the arrow I is observed; when users watch the LCD from a small viewing angle, the light transmitting along a direction of the arrow II is observed. The transmission path of the light transmitting along the direction of arrow I within the space layer 120 is longer than that of the light transmitting along the direction of arrow II. Thus, the light processed by the optical 100 shows different colors under different viewing angle (i.e. color washout phenomenon). Namely, though the optical filter 100 has the advantages of high color saturation and high light transmittance, color washout phenomenon appears when the optical filter 100 is applied to a wide viewing angel LCD.

### SUMMARY OF THE INVENTION

The present invention is direct to an optical filter, configured to solve the color washout of a conventional optical filter under a large viewing angle.

The present invention provides an optical filter including a bump, a first conformal transflective film, a conformal space layer and a second conformal transflective film. The bump has a surface, wherein different areas of the surface have different normal vectors, respectively. Moreover, the first conformal transflective film is disposed on the surface of the bump, while the conformal space layer is disposed on the first conformal transflective film. Besides, the second conformal transflective film is disposed on the conformal space layer. By modulating the thickness of the conformal space layer, different colors is shown after the light is processed by the first conformal transflective film, the conformal space layer and the second conformal transflective film.

In an embodiment of the present invention, the material of the aforementioned bump includes transparent materials, for example, and the bump has a refractive index less than that of the first conformal transflective film.

In another embodiment of the present invention, the shape of the aforementioned bump includes a hemisphere or a hemi ellipsoid. Moreover, the bump may also be a convex polyhedron that approximately forms a hemisphere or a hemi ellipsoid.

In a further embodiment of the present invention, the aforementioned bump may be disposed in a hemispherical space, and the bump may include a plurality of stacked frustum cones, the largest and the smallest circumference of each frustum cone are at the boundary of the hemispherical space.

Moreover, in still another embodiment of the present invention, the aforementioned bump may be disposed in a hemi ellipsoidal space, and the bump may be a plurality of stacked frustum elliptical cones, the largest and the smallest circumference of each frustum elliptical cone are at the boundary of the hemi ellipsoidal space.

In still another embodiment of the present invention, the material of the aforementioned first and second conformal transflective films may be silver or chromium, and the material of the conformal space layer includes silicon oxide, silicon nitride or other transparent dielectric materials.

In the present invention, films having a filtration function are formed on and conformal with a bump, thus, when a light processed by the optical filter is viewed in a large viewing angle, there will be no color washout phenomenon. Therefore, the optical filter of the present invention may be applied to large scaled display devices to provide a good display quality.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a schematic diagram of a conventional optical filter.

FIG. 2 is a cross-sectional view of an optical filter according to an embodiment of the present invention.

FIG. 3A is side view of an optical filter according to a second embodiment of the present invention.

FIG. 3B is a cross-sectional view of an optical filter according to a second embodiment of the present invention.

FIG. 4 is a cross-sectional view of an optical filter according to a third embodiment of the present invention.

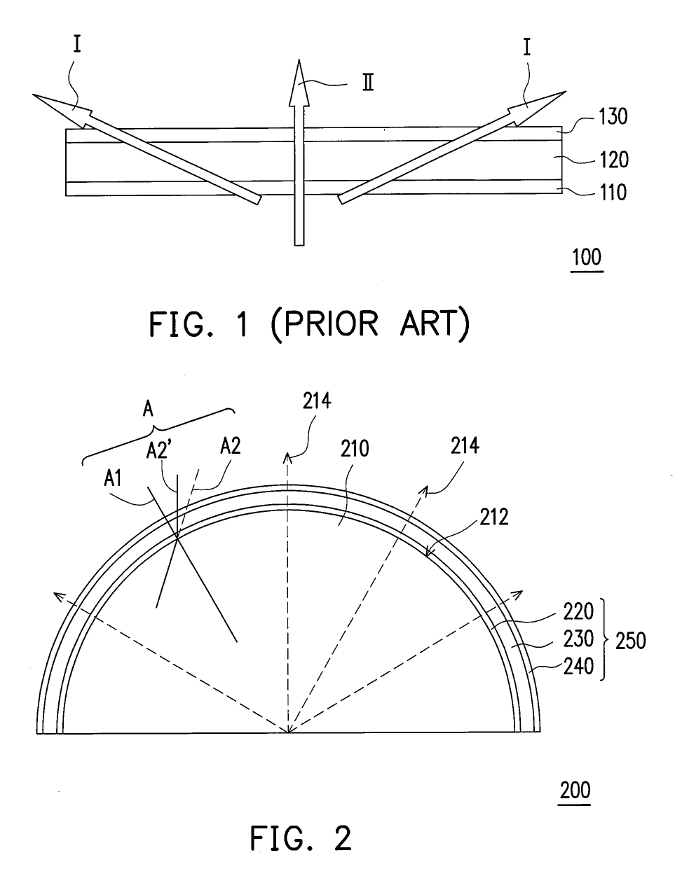

### DESCRIPTION OF EMBODIMENTS

From the related art we know that a structure with a transparent space layer disposed between two transflective films interferes the light which passing through the structure, and therefore has a filtration function. The thickness of the space layer is a key to adjust the color of emitted light. However, the conventional optical filter has a color washout phenomenon under a large viewing angle. Therefore, the present invention provides a novel optical filter, wherein the aforementioned films having a filtration function are formed on a bump, such that the color washout phenomenon under a large viewing angle will be obviously mitigated.

FIG. 2 is a cross-sectional view of an optical filter according to an embodiment of the present invention. Referring to FIG. 2, the optical filter 200 includes a bump 210, a first conformal transflective film 220, a conformal space layer 230 and a second conformal transflective film 240. The bump 210 has a surface 212, wherein different areas of the surface 212 have different normal vectors 214, respectively. Moreover, the first conformal transflective film 220 is disposed on the surface 212 of the bump 210, while the conformal space layer 230 is disposed on the first conformal transflective film 220. Besides, the second conformal transflective film 240 is disposed on the conformal space layer 230. By modulating the thickness of the conformal space layer 230, light with different colors is shown after the light A is processed by the first conformal transflective film 220, the conformal space layer 230 and the second conformal transflective film 240. The structure formed by the first conformal transflective film 220, the conformal space layer 230 and the second conformal transflective film 240 is referred to as filter structure 250.

The thickness of the conformal space layer 230 determines the colors of light A processed by the filter structure 250. Thus, for mitigating the color washout phenomenon under a large viewing angle, the distances that light A transmitted in the conformal space layer 230 when passing through the optical filter 200 under various viewing angle have to be approximately the same. In the present embodiment, different areas of the surface 212 of the bump 210 have different normal vectors 214, respectively. Thus, light A1 passing through the optical filter 200 under various viewing angle may vertically pass through the surface 212 of the bump 210 or vertically pass through a portion area of the filter structure 250. In other words, light A1 are emitted along the directions of the normal vectors 214 of different areas of the surface 212 of the bump 210, and the transmission paths that light A transmitted within the conformal space layer 230 in various directions are approximately the same. Therefore, when light A1 processed by the optical filter 200 are viewed in a large viewing angle, the color washout phenomenon will be significantly mitigated. In specific, the shape of the bump 210 may be hemisphere, hemi ellipsoid or other similar shapes. Moreover, the material of the bump 210 is preferably a transparent material such that light is capable of penetrating the bump 210 more efficiently to enter the filter structure 250.

Actually, light A passes through the filter structure 250 not only along the directions of the normal vectors 214, but also along the directions which are not parallel to the normal vectors 214 of each surface 212, shown as lights A2. In this case, the transmission paths that light A2 transmitted in the conformal space layer 230 are longer than the transmission path that light A1 transmitted in the conformal space layer 230, and the color shown by light A2 may have a color washout phenomenon. To close up the transmission paths that light A2 and A1 transmitted in the conformal space layer 230, designers may choose materials having a refractive index less than that of the first conformal transflective film 220 to fabricate the bump 210.

According to the Snell's Law, when a light enters an optically denser medium having a larger refractive index from an optically thinner medium having a smaller refractive index, the refraction angle is less than the incident angle, namely, a refracted light is deflected towards the normal direction. In the present embodiment, after the light A2 enters the first conformal transflective film 220 having a larger refractive index from the bump 210 having a smaller refractive index, the transmission direction of the light A2 will be more closer to the direction of the normal vector 214 due to the refraction (shown as light A2′ of FIG. 2). Therefore, the color of the light A2 processed by the filter structure 250 will be more closer to that of A1. In summary, the optical filter 200 of the present invention may effectively mitigate color washout phenomenon.

In addition, the material of the first conformal transflective film 220 and the second conformal transflective film 240 of the present embodiment may be transflective materials such as silver or chromium etc., and the material of the conformal space layer 230 includes silicon oxide, silicon nitride or other transparent dielectric materials. If the material of the conformal space layer 230 is SiO2, the thickness of the conformal space layer 230 may be in a range of 5˜120 nanometer, 120˜145 nanometer or 145˜190 nanometer, and the corresponding color of light processed by the filter structure 250 is blue, green, and red, respectively. In another aspect, if the material of the conformal space layer 230 is Si3N4, the thickness of the conformal space layer 230 may be in a range of 5˜70 nanometer, 70˜95 nanometer or 95˜120 nanometer, and the corresponding color of light processed by the filter structure 250 is blue, green, and red, respectively. It should be noted that the transmittance of the light processed by the filter structure 250 is above 70 percent. Thus, the optical filter 200 of the present invention has the advantages of high light transmittance, high color saturation and wide viewing angle.

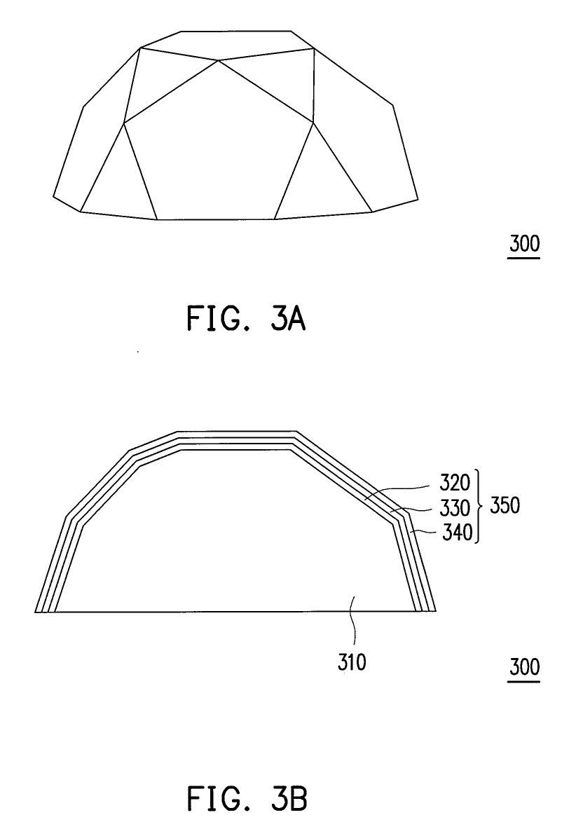

FIG. 3A is side view of an optical filter according to a second embodiment of the present invention. FIG. 3B is a cross-sectional view of an optical filter according to a second embodiment of the present invention. Referring to FIG. 3A and FIG. 3B, the optical filter 300 of the present embodiment is similar to the optical filter 200 of the first embodiment, the difference is that the bump 310 of the optical filter 300 is a convex polyhedron that approximately forms a hemisphere or a hemi ellipsoid. A convex polyhedron is defined as a polyhedron located at one side of a virtual plane passing through any one of its surfaces. In the optical filter 300 of the present embodiment, a first conformal transflective film 320, a conformal space layer 330 and a second conformal transflective film 340 are formed on the surface of the bump 310 having a shape of convex polyhedron. Such design of the optical filter 300 has the similar advantages with that of the optical filter 200. Moreover, the more the convex polyhedron is similar to a hemisphere or a hemi ellipsoid, the less color washout phenomenon occurs when the optical filter being viewed under a large viewing angle, and the better the optical filter 300 works.

It should be noted that the shape of the convex polyhedron is not limited to the shapes described in the aforementioned embodiments. Actually, as long as the convex polyhedron has a shape similar to a hemisphere or a hemi ellipsoid, the optical filter will have the aforementioned advantages.

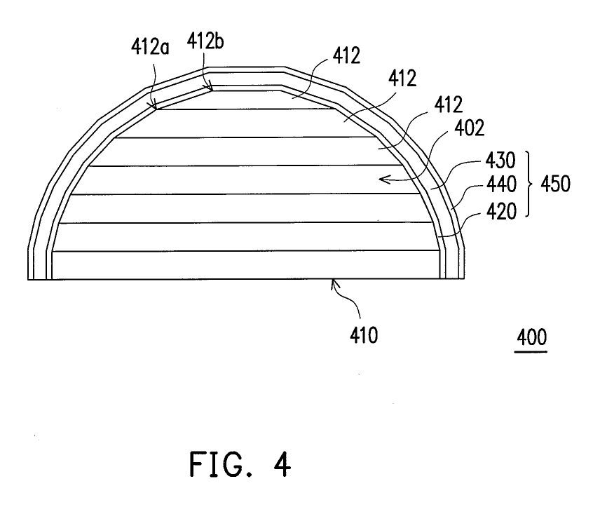

For example, FIG. 4 is a cross-sectional view of an optical filter according to a third embodiment of the present invention. The optical filter 300 of the present embodiment is similar to the optical filter 200 of the first embodiment, the difference will be described below. Referring to FIG. 4, the optical filter 400 may be disposed in a hemispherical space 402 or a hemi ellipsoidal space (not shown), and the bump 410 includes a plurality of frustum cones 412, the largest and the smallest circumference 412a and 412b of each frustum cone 412 are at the boundary of the hemispherical space 402 or the hemi ellipsoidal space (not shown). Generally, the frustum cone 412 is a three-dimensional structure with a circular top surface and a circular base surface, and the frustum cone is the remains of cutting and discarding a similar small cone from a big cone. In the present embodiment, the shape of the bump 410 is similar to a hemisphere or a hemi ellipsoid. The optical filter 400 formed by forming a first conformal transflective film 420, a conformal space layer 430 and a second conformal transflective film 440 on the bump 410 has the same advantages as the aforementioned optical filters 200 and 300 have. Namely, the optical filter 400 can be applied to a wide viewing angel display apparatus.

In summary, an optical filter of embodiments in the present invention has at least the following advantages:

1. The light processed by the optical filter of embodiments in the present invention has a high color saturation, and the optical filter of the present invention also has the advantage of high light transmittance.

2. The optical filter of embodiments in the present invention has approximately the same image quality under various viewing angel, and therefore the color washout phenomenon appeared under large viewing angle can be effectively mitigated.

3. The optical filter of embodiments in the present invention may be applied to the display apparatus to improve the display quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical filter, comprising:
a bump having a surface, wherein different areas of the surface have different normal vectors, respectively;
a first conformal transflective film, disposed on the surface of the bump;
a conformal space layer, disposed on the first conformal transflective film; and
a second conformal transflective film disposed on the conformal space layer, by modulating the thickness of the conformal space layer, different colors being shown after a light being processed by the first conformal transflective film, the conformal space layer and the second conformal transflective film.

2. The optical filter as claimed in claim 1, wherein a refractive index of the bump is less than that of the first conformal transflective film.

3. The optical filter as claimed in claim 1, wherein a material of the bump comprises transparent materials.

4. The optical filter as claimed in claim 1, wherein a shape of the bump comprises a hemisphere or a hemi ellipsoid.

5. The optical filter as claimed in claim 1, wherein the bump comprises a convex polyhedron, and a shape of the convex polyhedron is approximately a hemisphere or a hemi ellipsoid.

6. The optical filter as claimed in claim 1, wherein the bump is disposed within a hemispherical space or a hemi ellipsoidal space.

7. The optical filter as claimed in claim 6, wherein the bump comprises a plurality of stacked frustum cones.

8. The optical filter as claimed in claim 7, wherein a largest and a smallest circumference of each frustum cone are at a boundary of the hemispherical space.

9. The optical filter as claimed in claim 6, wherein the bump comprises a plurality of stacked frustum elliptical cones.

10. The optical filter as claimed in claim 9, wherein a largest and a smallest circumference of each frustum elliptical cone are at a boundary of the hemi ellipsoidal space.

11. The optical filter as claimed in claim 1, wherein a material of the first conformal transflective film comprises silver or chromium.

12. The optical filter as claimed in claim 1, wherein a material of the second conformal transflective film comprises silver or chromium.

13. The optical filter as claimed in claim 1, wherein a material of the conformal space layer comprises silicon oxide, silicon nitride or other transparent dielectric materials.
